(19) United States
(12) Patent Application Publication
(10) Pub. No.: US 2026/0189553 A1
(43) Pub. Date: Jul. 2, 2026

(54) System and method for authenticating users based on biometric identity data and environmental data

(71) Applicant: Bank of America Corporation, Charlotte, NC (US)

(72) Inventors: Adam K. King, Fort Mill, SC (US); Michael R. Young, Davidson, NC (US); Alexandra Rosalie Leicht, Charlotte, NC (US); Sanjay Lohar, Mint Hill, NC (US)

(21) Appl. No.: 19/007,802

(22) Filed: Jan. 2, 2025

(51) Int. Cl. H04L 9/40

(52) U.S. Cl. CPC H04L 63/0861

(57) ABSTRACT

A system includes a memory configured to store first biometric identity data associated with a user of a computing device, first environmental data associated with the computing device, and a software application. The system further includes a processor operably coupled to the memory and configured to receive a request to initiate an execution of a sequence of user interactions with the software application, receive, based on first sensor data, second biometric identity data, and receive, based on second sensor data, second environmental data. The processor is further configured to execute one or more machine-learning models trained to generate a multifactor authentication (MFA) value and a dynamic threshold based on whether the second biometric identity data and the second environmental data corresponds to the first biometric identity data and the first environmental data, respectively, and, in response, initiate the execution of the sequence of user interactions with the software application.

### TECHNICAL FIELD

The present disclosure relates generally to computing security, and, more specifically, to a system and method for authenticating users based on biometric identity data and environmental data.

### BACKGROUND

Certain web-based environments may include data being exchanged and stored across any number of computing systems and databases. For example, the data may include various user data or service data that may be stored to databases associated with respective entities, and that user data or service data may be exchanged between various centralized or decentralized servers and various computing systems for servicing end users. However, such web-based environments may be sometimes subjected to various threats and cyberattacks.

### SUMMARY

The system and methods implemented by the system as disclosed in the present disclosure provide technical solutions to the technical problems discussed above by authenticating users based on biometric identity data and environmental data. The disclosed system and methods provide several practical applications and technical advantages. Specifically, the present embodiments improve the security, reliability, and maintainability of software applications, systems, and sensitive user data, as well as the one or more processors and memory on which the software applications, systems, and sensitive user data may be executed and stored. The security, reliability, and maintainability of software applications, systems, and sensitive user data is improved by providing a biometric identity and environmental data authentication system that utilizes one or more machine-learning models trained and executed to generate a multifactor authentication (MFA) value and a dynamic threshold based on whether biometric identity data and environmental data captured at the time a user requests to initiate a sequence of user interactions with a software application corresponds to biometric identity data and environmental data associated with the user and stored over a period of time.

For example, in particular embodiments, the one or more machine-learning models may be trained to generate the MFA value by assigning one or more weights to each of the received biometric identity data and the received environmental data for comparison to the biometric identity data and the environmental data associated with the user that may be prestored to a database. The one or more machine-learning models may then generate an authentication decision by determining whether the generated MFA value satisfies the generated dynamic threshold, which may include a context-aware and adaptable threshold for evaluating the generated MFA value in real-time or near real-time. Specifically, the one or more machine-learning models may generate the authentication decision based on the comparison of the MFA value and the dynamic threshold as an indication of either a successful authentication or an unsuccessful authentication. In response to determining only a successful authentication, the execution of the sequence of user interactions with the software application may be initiated.

In this way, the present embodiments may identify, isolate, and preempt potential threats, adversarial attacks, cyberattacks, data breaches, deceptive operations (e.g., “scams,” “spoofing” attacks, phishing attacks, “vishing” attacks, and so forth), or other security vulnerabilities that may be associated with software applications, systems, and the transfer of sensitive user data. Specifically, by combining both biometric identity data associated with a user and environmental data associated with a computing device of the user as part of a context-aware and adaptable authentication mechanism, the present embodiments may prevent or reduce the frequency of deceptive operations (e.g., “scams,” “spoofing” attacks, phishing attacks, “vishing” attacks, and so forth) with respect to software applications, systems, and/or the transfer of sensitive user data before an execution of a user interaction or a sensitive data transfer is initiated and completed.

Moreover, by preempting potential user interactions or sensitive data transfers in association with deceptive operations before the execution of the user interaction or the sensitive data transfer is initiated and completed, the present embodiments may reduce unnecessary calls or queries to the databases into which sensitive data may be stored, and may thereby improve computer network efficiency, bandwidth, and data throughput.

The present embodiments are directed to systems and methods for authenticating users based on biometric identity data and environmental data. In particular embodiments, a system includes a memory configured to store first biometric identity data associated with a user of a computing device, first environmental data associated with the computing device, and at least one software application. In particular embodiments, the system further includes one or more processors operably coupled to the memory may be configured to receive a request to initiate an execution of a sequence of user interactions with the at least one software application.

In particular embodiments, the one or more processors may be further configured to receive, based on first sensor data obtained from one or more first sensors of the computing device, second biometric identity data associated with the user. In particular embodiments, the one or more processors may be further configured to receive, based on second sensor data obtained from one or more second sensors of the computing device, second environmental data associated with the computer device.

For example, in one embodiment, one or more of the first biometric identity data or the second biometric identity data may include one or more of image data associated with the user, voice data associated with the user, fingerprint data associated with the user, handprint data associated with the user, eye tracking data associated with the user, face tracking data associated with the user, hand tracking data associated with the user, full-body tracking data associated with the user, tactile data associated with the user, or an avatar associated with the user.

In one embodiment, one or more of the first environmental data or the second environmental data may include one or more of a location of the computing device, an air quality associated with the location of the computing device, a degree associated with the location of the computing device, a humidity associated with the location of the computing device, a pollution level associated with the location of the computing device, a weather forecast associated with the location of the computing device, a noise level associated with the location of the computing device, an ambient light associated with the location of the computing device, an atmospheric pressure associated with the location of the computing device, or a time of day associated with the location of the computing device.

In particular embodiments, the one or more processors may be further configured to execute one or more machine-learning models trained to generate a multifactor authentication (MFA) value and a dynamic threshold based at least in part on whether the second biometric identity data and the second environmental data corresponds to the first biometric identity data and the first environmental data, respectively. In one embodiment, the dynamic threshold may include an adaptable acceptable range for the MFA value so as to authenticate the user. In one embodiment, the one or more machine-learning models may include one or more of a neuromorphic image compression (NIC) model, a convolutional neural network (CNN), a spiking neural network (SNN), an autoencoder (AE), a variational autoencoder (VAE), a generative adversarial network (GAN), or a bidirectional generative adversarial network (BiGAN).

In particular embodiments, the one or more processors may be further configured to execute the one or more machine-learning models further trained to generate the MFA value by assigning one or more weights to each of the second biometric identity data and the second environmental data. In particular embodiments, the one or more processors may be further configured to execute the one or more machine-learning models further trained to generate the dynamic threshold based at least in part on real-time or near real-time first environmental data associated with the computing device.

In particular embodiments, in response to determining that the MFA value satisfies the dynamic threshold, the one or more processors may be further configured to initiate the execution of the sequence of user interactions with the at least one software application. In particular embodiments, in response to determining that the MFA value fails to satisfy the dynamic threshold, the one or more processors may be further configured to forgo initiating the execution of the sequence of user interactions with the at least one software application.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a cloud computing system, in accordance with certain aspects of the present disclosure;

FIG. 2 illustrates a diagram of a biometric identity and environmental data authentication system for authenticating users based on biometric identity data and environmental data, in accordance with one or more embodiments of the present disclosure; and

FIG. 3 illustrates a flowchart of an example method for authenticating users based on biometric identity data and environmental data, in accordance with one or more embodiments of the present disclosure.

### DETAILED DESCRIPTION

### Example System

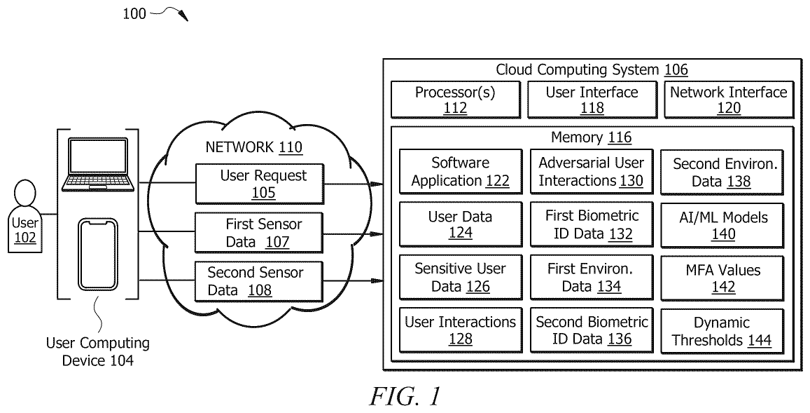

FIG. 1 is a block diagram of a cloud computing system 100. In particular embodiments, the system 100 may include a user computing device 104 associated with a user 102, a cloud computing system 106, and a network 110. In particular embodiments, the user 102 may include a user associated with an institution, an organization, or an entity that receives user data (e.g., user data 124) and hosts and maintain sensitive user data (e.g., sensitive user data 126) that may be associated with the user 102. The network 110 enables communications and exchanges of data among components of the system 100, such as the user computing device 104 and the cloud computing system 106.

In general, the system 100 may be utilized to authenticate users based on real-time or near real-time biometric identity data (e.g., second biometric identity data 136) and environmental data (e.g., second environmental data 138) that may be associated with the user 202. In particular embodiments, the cloud computing system 106 may include one or more processor(s) 112 in signal communication with a memory 116. The memory 116 stores a software application 122 that when executed by the processor(s) 112, cause the processor(s) 112 to perform one or more functions described herein. For example, when the software application 122 is executed, the processor(s) 112 may generate a multifactor authentication (MFA) value (e.g., MFA value 142) and a dynamic threshold (e.g., dynamic threshold 144) based on a comparison of the biometric identity data (e.g., second biometric identity data 136) and the environmental data (e.g., second environmental data 138) and biometric identity data (e.g., first biometric identity data 132) and environmental data (e.g., first environmental data 134) that may be prestored to the memory 116.

The cloud computing system 100 may be configured as shown, or in any other configuration. In one embodiment, the cloud computing system 106 may include a private cloud computing and storage system, which may include, for example, a cloud computing environment and infrastructure that may be managed, controlled, and dedicated to a single organization or entity. In another embodiment, the cloud computing system 106 may include a hybrid cloud computing and storage system, which may include, for example, a mixed computing environment and infrastructure in which software applications are executing utilizing some combination of computing, storage, and services in both private cloud environments and public cloud environments. Still, in another embodiment, the cloud computing system 106 may include a public cloud computing and storage system, which may include, for example, a cloud computing environment and infrastructure that may be serviced to any number of organizations or entities as virtual resources accessible over the internet.

### System Components

### Network

The network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Cloud Computing System

In particular embodiments, the cloud computing system 106 may include any computing system that may be utilized to process data and communicate with computing devices (e.g., user computing device 104), databases, or other computing systems via the network 110. The cloud computing system 106 may be utilized to oversee operations of the processor(s) 112. In particular embodiments, the cloud computing system 106 may include the processor(s) 112 in signal communication with a network interface 120, a user interface 118, and memory 116. The cloud computing system 106 may be configured as shown, or in any other configuration.

The processor(s) 112 may include one or more processors operably coupled to the memory 116. The processor(s) 112 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor(s) 112 may be a programmable logic device, a microcontroller, a microprocessor, or any suitable combination of the preceding. The processor(s) 112 may be communicatively coupled to and in signal communication with the network interface 120, user interface 118, and memory 116. The one or more processors may be utilized to process data and may be implemented in hardware, software, or some combination thereof.

For example, the processor(s) 112 may be 8-bit, 16-bit, 32-bit, 64-bit or of any other suitable architecture. The processor(s) 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processor(s) 112 are configured to implement various instructions. For example, the one or more processors may be utilized to execute the software application 122 to implement the functions disclosed herein, such as some or all of those described with respect to FIGS. 1-3. In some embodiments, the function described herein is implemented using logic units, FPGAs, ASICs, DSPs, or any other suitable hardware or electronic circuitry.

The network interface 120 may be utilized to enable wired and/or wireless communications (e.g., via the network 110). The network interface 120 may be utilized to communicate data between the cloud computing system 106 and other network devices, systems, or domain(s). For example, the network interface 120 may comprise a WIFI interface, a local area network (LAN) interface, a wide area network (WAN) interface, a modem, a switch, or a router. The processor(s) 112 may be configured to send and receive data using the network interface 120. The network interface 120 may be configured to use any suitable type of communication protocol.

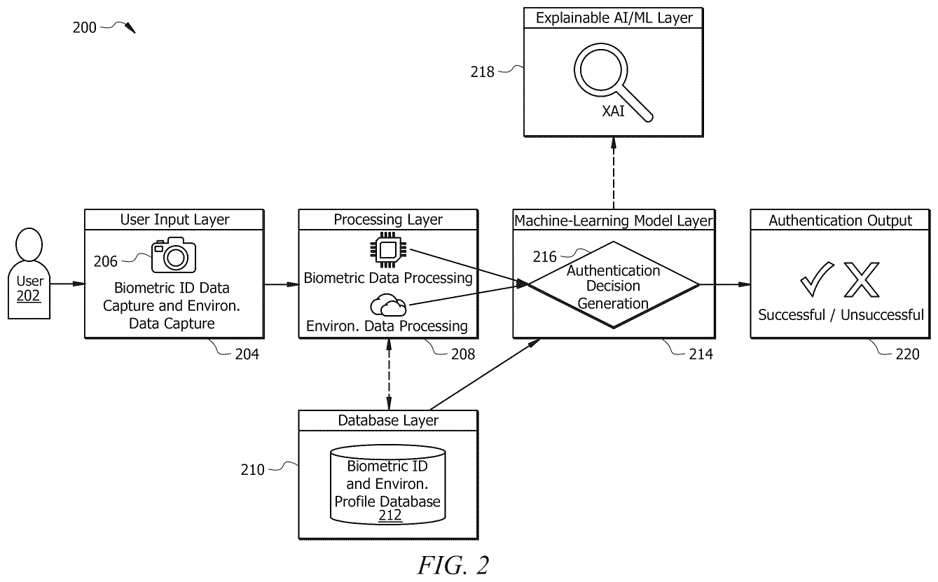

The memory 116 may be volatile or non-volatile and may include a read-only memory (ROM), random-access memory (RAM), ternary content-addressable memory (TCAM), dynamic random-access memory (DRAM), and static random-access memory (SRAM), or other non-transitory computer-readable medium. The memory 116 may be implemented using one or more disks, tape drives, solid-state drives, and/or the like. As will be discussed in greater detail below with respect to FIG. 2, the memory 116 may be operable to store the software application 122, user data 124, sensitive user data 126, user interactions 128, adversarial user interactions 130, first biometric identity data 132, first environmental data 134, second biometric identity data 136, second environmental data 138, one or more generative artificial intelligence (AI)/machine-learning (ML) models 140, MFA values 142, dynamic thresholds 144, and/or any other data, instructions, or compute engines.

The memory 116 may also store instances of software application 122 that may be executing within the system 100. In one embodiment, the instances of a software application 122 may include any number of instances a large software application suitable for hosting and servicing thousands or millions of individual users 102 that may interact via user computing devices 104 with the cloud computing system 106. The users 102 may be further associated with the sensitive user data 126. In accordance with the presently disclosed embodiments, the memory 116 may store first biometric identity data 132 associated with respective users 102 and first environmental data 134 associated with respective user computing devices 104 that may be accumulated over a period of time for authenticating users 102 in a context-aware manner.

### Processor(s)

In particular embodiments, the processor(s) 112 may be utilized to authenticate users 102 based on real-time or near real-time second biometric identity data 136 and second environmental data 138. In accordance with the presently disclosed embodiments, the processor(s) 112 may receive a user request 105 from the user computing device 104 to initiate an execution of a sequence of user interactions 128 with the software application 122. In particular embodiments, the processor(s) 112 may receive, based on first sensor data 107 obtained from one or more first sensors of the user computing device 104, second biometric identity data 136 associated with the user 102 and receive, based on second sensor data 108 obtained from one or more second sensors of the user computing device 104, second environmental data 138 associated with the user computer device 104.

In particular embodiments, the processor(s) 112 may execute one or more machine-learning models 140 trained to generate a multifactor authentication (MFA) value 142 and a dynamic threshold 144 based on whether the second biometric identity data 136 and the second environmental data 138 corresponds to the first biometric identity data 132 and the first environmental data 134, respectively. In one embodiment, the one or more machine-learning models 140 may include one or more of a language model (LM), a large language model (LLM), a bidirectional and auto-regressive transformer (BART) model, a bidirectional encoder representations for transformer (BERT) model, or a generative pre-trained transformer (GPT) model. In another embodiment, the one or more machine-learning models 140 may include one or more of a neuromorphic image compression (NIC) model, a convolutional neural network (CNN), a spiking neural network (SNN), an autoencoder (AE), a variational autoencoder (VAE), a generative adversarial network (GAN), or a bidirectional generative adversarial network (BiGAN).

In particular embodiments, in response to determining that the MFA value 142 satisfies the dynamic threshold 144, the processor(s) 112 may initiate the execution of the sequence of user interactions 128 with the software application 122. In particular embodiments, the one or more machine-learning models 140 may be trained based on a training data set of user data 124, user interactions 128, adversarial user interactions 130, first biometric identity data 132, and first environmental data 134 that may be associated with any number of legitimate users 102 and/or adversarial users interacting with the software application 122 via a computing device 104.

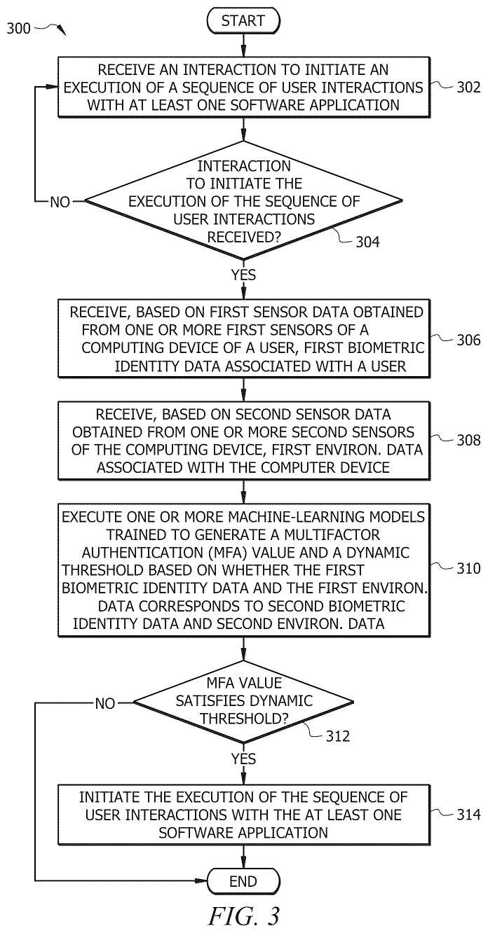

Thus, as will be discussed in further detail below with respect to FIGS. 2 and 3, in accordance with the presently disclosed embodiments, the processor(s) 112 may identify, isolate, and preempt adversarial user interactions 130, such as deceptive operations (e.g., “scams,” “spoofing” attacks, phishing attacks, “vishing” attacks, and so forth) that may be associated with the software application 122 and the sensitive user data 126. Specifically, by combining both biometric identity data (e.g., second biometric identity data 136) associated with a user 102 and environmental data (e.g., second environmental data 138) associated with the computing device 104 as part of a context-aware and adaptable authentication mechanism, the processor(s) 112 may prevent or reduce the frequency of deceptive operations (e.g., “scams,” “spoofing” attacks, phishing attacks, “vishing” attacks, and so forth) with respect to software application 122 and/or the transfer of sensitive user data 126 before an execution of a user interaction 128 or a sensitive user data 126 transfer is initiated and completed.

### Authenticating Users Based on Biometric Identity Data and Environmental Data

Embodiments of the present disclosure discuss techniques for authenticating users based on biometric identity data and environmental data.

FIG. 2 illustrates a diagram of a biometric identity and environmental data authentication system 200 for authenticating users based on biometric identity data and environmental data, in accordance with certain aspects of the present disclosure. In particular embodiments, the biometric identity and environmental data authentication system 200 may correspond to the cloud computing system 106 and may be executed by the processor(s) 112 as described above with respect to FIG. 1. As depicted, the biometric identity and environmental data authentication system 200 may include a user input layer 204 that may be associated with a user 202, a processing layer 208, a database layer 210, a machine-learning model layer 214 that may generate a final user authentication output 220, and an AI/ML explainability layer 218 that may be associated with the machine-learning model layer 214.

In particular embodiments, as further depicted by the biometric identity and environmental data authentication system 200, the user input layer 204 may include one or more sensors 206 that may be suitable for capturing biometric identity data (e.g., second biometric identity data 136) and environmental data (e.g., second environmental data 138) that may be associated with the user 202. For example, in one embodiment, the user input layer 204 may correspond to the user computing device 104 as described above with respect to FIG. 1. In one embodiment, the one or more sensors 206 may continuously capture the biometric identity data (e.g., second biometric identity data 136) and the environmental data (e.g., second environmental data 138) as the user 202 interacts with the user input layer 204.

In another embodiment, the user input layer 204 may be instructed by the processing layer 208 to cause the one or more sensors 206 to capture the biometric identity data (e.g., second biometric identity data 136) and the environmental data (e.g., second environmental data 138) in response to a user request (e.g., user request 105) to initiate an execution of a sequence of user interactions 128 with an instance of a software application (e.g., software application 122) that may be executing on the user input layer 204.

For example, in particular embodiments, the user 202 may request to initiate an execution of a sequence of user interactions with an instance of a software application (e.g., software application 122) that may include accessing and viewing sensitive user data 126, transferring data units between different sensitive user profiles, opening one or more new sensitive user profiles, linking a sensitive user profile to a third-party user profile associated with the same user, instantiating a new or an updated physical card or virtual card that may be associated with a user's sensitive user profile, or other similar user request (e.g., user request 105) that may be performed by the user 202.

In particular embodiments, the one or more sensors 206 may capture one or more of image data associated with the user 202, voice data associated with the user 202, fingerprint data associated with the user 202, handprint data associated with the user 202, eye tracking data associated with the user 202, face tracking data associated with the user 202, hand tracking data associated with the user 202, full-body tracking data associated with the user 202, tactile data associated with the user 202, or a unique avatar associated with the user 202 as the biometric identity data (e.g., second biometric identity data 136).

Similarly, in particular embodiments, the one or more sensors 206 may capture one or more of a location of the user input layer 204, an air quality associated with the location of the user input layer 204, a degree associated with the location of the user input layer 204, a humidity associated with the location of the user input layer 204, a pollution level associated with the location of the user input layer 204, a weather forecast associated with the location of the user input layer 204, a noise level associated with the location of the user input layer 204, an ambient light associated with the location of the user input layer 204, an atmospheric pressure associated with the location of the user input layer 204, or a time of day associated with the location of the user input layer 204.

In particular embodiments, upon the one or more sensors 206 capturing the biometric identity data (e.g., second biometric identity data 136) and the environmental data (e.g., second environmental data 138), the user input layer 204 may then provide the biometric identity data (e.g., second biometric identity data 136) and the environmental data (e.g., second environmental data 138) to the processing layer 208. In some embodiments, the processing layer 208 may correspond to the one or more processor(s) 112 as described above with respect to FIG. 1.

In particular embodiments, upon the processing layer 208 receiving the biometric identity data (e.g., second biometric identity data 136) and the environmental data (e.g., second environmental data 138), the processing layer 208 may then process the raw biometric identity data and the environmental data by executing, for example, one or more feature extraction algorithms suitable for extracting identifiable data from the biometric identity data (e.g., image data, voice data, fingerprint data, handprint data, eye tracking data, face tracking data, hand tracking data, and so forth) and the environmental data (e.g., location data, air quality data, degree data, humidity data, pollution level data, weather forecast data, noise level data, ambient light data, atmospheric pressure data, and so forth) for comparison to biometric identity data (e.g., first biometric identity data 132) and environmental data (e.g., first environmental data 134) associated with the user 202 that may be prestored to a database 212 (e.g., relational database) of database layer 210.

In particular embodiments, upon the processing layer 208 processing the biometric identity data (e.g., second biometric identity data 136) and the environmental data (e.g., second environmental data 138), the processing layer 208 may then provide the processed biometric identity data (e.g., second biometric identity data 136) and environmental data (e.g., second environmental data 138) to the machine-learning model layer 214. In particular embodiments, the machine-learning model layer 214 may correspond to the one or more machine-learning models 140 as described above with respect to FIG. 1.

Specifically, in accordance with the presently disclosed embodiments, the machine-learning model layer 214 may be trained to generate a multifactor authentication (MFA) value (e.g., MFA value 142) and a dynamic threshold (e.g., dynamic threshold 144) based on whether the biometric identity data (e.g., second biometric identity data 136) and the environmental data (e.g., second environmental data 138) corresponds to the biometric identity data (e.g., first biometric identity data 132) and the environmental data (e.g., first environmental data 134) prestored to the database 212, respectively. For example, in one embodiment, the MFA value (e.g., MFA value 142) may include a numerical value that may be generated by the machine-learning model layer 214 indicative of a “strength” of the match between the biometric identity data (e.g., second biometric identity data 136) and the environmental data (e.g., second environmental data 138) to the biometric identity data (e.g., first biometric identity data 132) and the environmental data (e.g., first environmental data 134), respectively.

In particular embodiments, the machine-learning model layer 214 may be trained to generate the MFA value (e.g., MFA value 142) by assigning one or more weights to each of the biometric identity data (e.g., second biometric identity data 136) and the environmental data (e.g., second environmental data 138) for comparison to the biometric identity data (e.g., first biometric identity data 132) and the environmental data (e.g., first environmental data 134) prestored to the database 212. For example, in particular embodiments, the machine-learning model layer 214 may assign weights on a scale of “0.0” to “1.0” based on how well the biometric identity data (e.g., second biometric identity data 136) and the environmental data (e.g., second environmental data 138) compares to the biometric identity data (e.g., first biometric identity data 132) and the environmental data (e.g., first environmental data 134) prestored to the database 212. Specifically, a weight of “1.0” may indicate a highest likelihood of a match while a weight of “0.0” may indicate a lowest likelihood of a match.

For example, in one embodiment, the biometric identity data (e.g., second biometric identity data 136) may include an image of the user 202, in which a face of the user 202 may be ascertainable from the image of the user 202, but a retina or iris of the user 202 may not be ascertainable from the image of the user 202. In such an instance, the machine-learning model layer 214 may assign a weight of “0.8” to the biometric identity data (e.g., second biometric identity data 136) indicating a high likelihood that the biometric identity data (e.g., second biometric identity data 136) matches to the biometric identity data (e.g., first biometric identity data 132) prestored to the database 212.

Continuing the aforementioned example, the environmental data (e.g., second environmental data 138) may include a location of the user 202 (e.g., “San Francisco, California”), a time of day associated with the request received from the user 202 (e.g., “08:00 AM”), and an atmospheric pressure associated with the location of the user 202 (e.g., “1021 hectopascal (hPa)”). In such an instance, the machine-learning model layer 214 may assign a weight of “0.9” to the environmental data (e.g., second environmental data 138) indicating a high likelihood that the environmental data (e.g., second environmental data 138) matches to the environmental data (e.g., first environmental data 134) prestored to the database 212. For example, the environmental data (e.g., first environmental data 134) prestored to the database 212 may include a typical location of the user 202 (e.g., “San Francisco, California”), typical times of day associated with requests received from the user 202 (e.g., “morning rush-hour times of 08:00 AM -10:00 AM”), and typical atmospheric pressure values associated with the location of the user 202 (e.g., “within a range of approximately 1018 hPa to 1022 hPa”).

In particular embodiments, based on the assigned weight of “0.8” to the biometric identity data (e.g., second biometric identity data 136) and the assigned weight of “0.9” to the environmental data (e.g., second environmental data 138), the machine-learning model layer 214 may generate an MFA value (e.g., MFA value 142) of “1.7” by summing the assigned weights. In particular embodiments, the machine-learning model layer 214 may then generate an authentication decision 216 by determining whether the generated MFA value of “1.7” satisfies a dynamic threshold (e.g., dynamic threshold 144). The dynamic threshold (e.g., dynamic threshold 144) may be generated for defining an adaptable acceptable range for the MFA value (e.g., MFA value 142) based on real-time or near real-time biometric identity data and environmental data for authenticating the user 202.

For example, in particular embodiments, the machine-learning model layer 214 may be trained to generate a context-aware and adaptable dynamic threshold (e.g., dynamic threshold 144) for evaluating the MFA value (e.g., MFA value 142). In particular embodiments, the dynamic threshold (e.g., dynamic threshold 144) may be context-aware and adaptable (e.g., in real-time or near real-time) in that the dynamic threshold (e.g., dynamic threshold 144) may be generated utilizing one or more of the biometric identity data (e.g., second biometric identity data 136), the environmental data (e.g., second environmental data 138), the biometric identity data (e.g., first biometric identity data 132), and the environmental data (e.g., first environmental data 134).

In one embodiment, the dynamic threshold (e.g., dynamic threshold 144) may be generated for defining an adaptable acceptable range for the MFA value (e.g., MFA value 142) based on real-time or near real-time biometric identity data and environmental data for authenticating the user 202. For example, the machine-learning model layer 214 may be trained to adjust the dynamic threshold (e.g., dynamic threshold 144) based on authentication security conditions, such that the biometric identity and environmental data authentication system 200 may allow for a stricter authentication mechanism during certain user 202 scenarios or a more lenient authentication mechanism during other user 202 scenarios (e.g., a stricter authentication mechanism when the user 202 is in an unexpected location or unusual weather conditions as opposed to a more lenient authentication mechanism when the user 202 is in an expected location or expected weather conditions).

That is, the machine-learning model layer 214 may be trained to dynamically adjust the dynamic threshold (e.g., dynamic threshold 144) based on real-time or near real-time biometric identity data and environmental data. For example, if the user 202 is attempting to interact with an instance of the software application (e.g., software application 122) from a location with weather conditions in which the user 202 is expected to be physically located, the dynamic threshold (e.g., dynamic threshold 144) is dynamically adjusted to be lower. On the other hand, if the user 202 is attempting to interact with an instance of the software application (e.g., software application 122) from a location with weather conditions that is unexpected, the dynamic threshold (e.g., dynamic threshold 144) is dynamically adjusted to be higher.

Specifically, in particular embodiments, based on one or more of the biometric identity data (e.g., second biometric identity data 136), the environmental data (e.g., second environmental data 138), the biometric identity data (e.g., first biometric identity data 132), and the environmental data (e.g., first environmental data 134), the machine-learning model layer 214 may generate a dynamic threshold (e.g., dynamic threshold 144) that may be adaptably increased or decreased in accordance with the real-time or near real-time biometric identity data and environmental data. For example, in one embodiment, the machine-learning model layer 214 may generate a dynamic threshold (e.g., dynamic threshold 144) that may range from “1.0” to “3.0,” in which the MFA value (e.g., MFA value 142) can satisfy the dynamic threshold (e.g., dynamic threshold 144) only when its value is equal to or greater than “1.0.”

Thus, referring again to the aforementioned example above, the generated MFA value of “1.7” satisfies a dynamic threshold having a range from “1.0” to “3.0.” As previously noted, the MFA value (e.g., MFA value 142) may include a numerical value that may be generated by the machine-learning model layer 214 indicative of a “strength” of the match between the biometric identity data (e.g., second biometric identity data 136) and the environmental data (e.g., second environmental data 138) to the biometric identity data (e.g., first biometric identity data 132) and the environmental data (e.g., first environmental data 134), respectively. Thus, when the generated MFA value (e.g., MFA value 142) satisfies the dynamic threshold (e.g., dynamic threshold 144), the user 202 is authenticated.

As a further illustration of the context-awareness and adaptability of the dynamic threshold (e.g., dynamic threshold 144), in one embodiment, the environmental data (e.g., second environmental data 138) may include a location of the user 202 (e.g., “Madison, Wisconsin”), a time of day associated with the request received from the user 202 (e.g., “03:00 AM”), and an atmospheric pressure value associated with the location of the user 202 (e.g., “1013 hPa”). In the present example, the machine-learning model layer 214 may assign a weight of “0.2” to the environmental data (e.g., second environmental data 138) indicating a low likelihood that the environmental data (e.g., second environmental data 138) matches to the environmental data (e.g., first environmental data 134) prestored to the database 212. In this example, based on the assigned weight of “0.8” to the biometric identity data (e.g., second biometric identity data 136) and the assigned weight of “0.2” to the environmental data (e.g., second environmental data 138), the machine-learning model layer 214 may generate an MFA value (e.g., MFA value 142) of “1.0” by summing the assigned weights.

In accordance with the presently disclosed embodiments, because the location of the user 202 (e.g., “Madison, Wisconsin”) and the time of day associated with the request received from the user 202 (e.g., “03:00 AM”) does not match to the expected location of the user 202 (e.g., “San Francisco, California”) and the expected times of day for requests received from the user 202 (e.g., “08:00 AM-10:00 AM”), the machine-learning model layer 214 may generate a dynamic threshold (e.g., dynamic threshold 144) that ranges from “2.0” to “3.0,” in which the MFA value (e.g., MFA value 142) can satisfy the dynamic threshold (e.g., dynamic threshold 144) only when its value is equal to or greater than “2.0.” Thus, the generated MFA value of “1.0” fails to satisfy a dynamic threshold having a range from “2.0” to “3.0,” even though an MFA value of “1.0” was previously acceptable under different environmental data.

In particular embodiments, as further depicted by FIG. 2, the machine-learning model layer 214 may then generate the authentication decision 216 based on the comparison of the MFA value (e.g., MFA value 142) and the dynamic threshold (e.g., dynamic threshold 144) as an indication of either a successful authentication output 220 or an unsuccessful authentication output 220. In accordance with the presently disclosed embodiments, in response to determining a successful authentication output 220, the execution of the sequence of user interactions 128 with an instance of the software application (e.g., software application 122) executing on the user input layer 204 may be initiated.

On the other hand, in response to determining an unsuccessful authentication output 220, the execution of the sequence of user interactions 128 with an instance of the software application (e.g., software application 122) executing on the user input layer 204 may be forgone. For example, in one embodiment, in response to determining an unsuccessful authentication output 220, the processing layer 208 may provide one or more requests to the user 202 via the user input layer 204 for additional verification data, such as an input of a one-time password (OTP), an input of answers to one or more personalized security questions, or other similar verification data that may be inputted by the user 202.

FIG. 3 illustrates a flowchart of an example method 300 for authenticating users based on biometric identity data and environmental data, in accordance with one or more embodiments of the present disclosure. The method 300 may be performed utilizing the one or more processor(s) 112 of cloud computing system 106 as described above with respect to FIG. 1. The method 300 may begin at block 302 with the processor(s) 112 receiving a request to initiate an execution of a sequence of user interactions with the at least one software application. For example, in one embodiment, the processor(s) 112 may receive a user request (e.g., user request 105) to initiate an execution of a sequence of user interactions 128 with an instance of a software application (e.g., software application 122) that may be executing on the user input layer 204.

The method 300 may then continue at decision 304 with the processor(s) 112 confirming whether the request to initiate the execution of a sequence of user interactions with the at least one software application has been received. In one embodiment, in response to confirming that the request (e.g., user request 105) to initiate the execution of a sequence of user interactions with the at least one software application has not been received (e.g., at decision 304), the method 300 may return to block 302 as discussed above. On the other hand, in response to confirming that the request (e.g., user request 105) to initiate the execution of a sequence of user interactions with the at least one software application has been received (e.g., at decision 304), the method 300 may then continue at block 306 with the processor(s) 112 receiving, based on first sensor data obtained from one or more first sensors of a computing device, first biometric identity data associated with the user.

The method 300 may then continue at block 308 with the processor(s) 112 receiving, based on second sensor data obtained from one or more second sensors of the computing device, first environmental data associated with the computer device. For example, in one embodiment, the user input layer 204 may include one or more sensors 206 that may be suitable for capturing biometric identity data (e.g., second biometric identity data 136) and environmental data (e.g., second environmental data 138) that may be associated with the user 202. The method 300 may then continue at block 310 with the processor(s) 112 executing one or more machine-learning models trained to generate a multifactor authentication (MFA) value and a dynamic threshold based at least in part on whether the first biometric identity data and the first environmental data corresponds to second biometric identity data and second environmental data, respectively.

For example, in particular embodiments, the machine-learning model layer 214 may be trained to generate a multifactor authentication (MFA) value (e.g., MFA value 142) and a dynamic threshold (e.g., dynamic threshold 144) based on whether the biometric identity data (e.g., second biometric identity data 136) and the environmental data (e.g., second environmental data 138) corresponds to the biometric identity data (e.g., first biometric identity data 132) and the environmental data (e.g., first environmental data 134), respectively. The machine-learning model layer 214 may be further trained to generate a context-aware and adaptable dynamic threshold (e.g., dynamic threshold 144) for evaluating the MFA value (e.g., MFA value 142).

The method 300 may then continue at decision 312 with the processor(s) 112 determining whether the MFA value satisfies the dynamic threshold. In one embodiment, in response to determining that the MFA value (e.g., MFA value 142) fails to satisfy the dynamic threshold (e.g., dynamic threshold 144) (e.g., at decision 312), the method 300 may terminate. On the other hand, in response to determining that the MFA value (e.g., MFA value 142) satisfies the dynamic threshold (e.g., dynamic threshold 144) (e.g., at decision 312), the method 300 may then continue at block 314 with the processor(s) 112 initiating the execution of the sequence of user interactions with the at least one software application.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store first biometric identity data associated with a user of a computing device, first environmental data associated with the computing device, and at least one software application; and
one or more processors operably coupled to the memory and configured to:
receive a request to initiate an execution of a sequence of user interactions with the at least one software application, and, in response:
receive, based on first sensor data obtained from one or more first sensors of the computing device, second biometric identity data associated with the user;
receive, based on second sensor data obtained from one or more second sensors of the computing device, second environmental data associated with the computing device,
execute one or more machine-learning models trained to generate a multifactor authentication (MFA) value and a dynamic threshold based at least in part on whether the second biometric identity data and the second environmental data corresponds to the first biometric identity data and the first environmental data, respectively, wherein the dynamic threshold comprises an adaptable acceptable range for the MFA value so as to authenticate the user; and
in response to determining that the MFA value satisfies the dynamic threshold, initiate the execution of the sequence of user interactions with the at least one software application.

2. The system of claim 1, wherein one or more of the first biometric identity data or the second biometric identity data comprises one or more of image data associated with the user, voice data associated with the user, fingerprint data associated with the user, handprint data associated with the user, eye tracking data associated with the user, face tracking data associated with the user, hand tracking data associated with the user, full-body tracking data associated with the user, tactile data associated with the user, or an avatar associated with the user.

3. The system of claim 1, wherein one or more of the first environmental data or the second environmental data comprises one or more of:
a location of the computing device;
an air quality associated with the location of the computing device;
a degree associated with the location of the computing device;
a humidity associated with the location of the computing device;
a pollution level associated with the location of the computing device;
a weather forecast associated with the location of the computing device;
a noise level associated with the location of the computing device,
an ambient light associated with the location of the computing device;
an atmospheric pressure associated with the location of the computing device; or
a time of day associated with the location of the computing device.

4. The system of claim 1, wherein the one or more processors are further configured to execute the one or more machine-learning models further trained to generate the MFA value by assigning one or more weights to each of the second biometric identity data and the second environmental data.

5. The system of claim 1, wherein the one or more processors are further configured to execute the one or more machine-learning models further trained to generate the dynamic threshold based at least in part on real-time or near real-time first environmental data associated with the computing device.

6. The system of claim 1, wherein the one or more processors are further configured to:
in response to determining that the MFA value fails to satisfy the dynamic threshold, forgo initiating the execution of the sequence of user interactions with the at least one software application.

7. The system of claim 1, wherein the one or more machine-learning models comprises one or more of a neuromorphic image compression (NIC) model, a convolutional neural network (CNN), a spiking neural network (SNN), an autoencoder (AE), a variational autoencoder (VAE), a generative adversarial network (GAN), or a bidirectional generative adversarial network (BiGAN).

8. A method, comprising:
receiving a request to initiate an execution of a sequence of user interactions with at least one software application, and, in response:
receiving, based on first sensor data obtained from one or more first sensors of a computing device, first biometric identity data associated with a user of the computing device;
receiving, based on second sensor data obtained from one or more second sensors of the computing device, first environmental data associated with the computing device;
executing one or more machine-learning models trained to generate a multifactor authentication (MFA) value and a dynamic threshold based at least in part on whether the first biometric identity data and the first environmental data corresponds to second biometric identity data associated with the user and second environmental data associated with the computing device, respectively, wherein the dynamic threshold comprises an adaptable acceptable range for the MFA value so as to authenticate the user; and
in response to determining that the MFA value satisfies the dynamic threshold, initiating the execution of the sequence of user interactions with the at least one software application.

9. The method of claim 8, wherein one or more of the first biometric identity data or the second biometric identity data comprises one or more of image data associated with the user, voice data associated with the user, fingerprint data associated with the user, handprint data associated with the user, eye tracking data associated with the user, face tracking data associated with the user, hand tracking data associated with the user, full-body tracking data associated with the user, tactile data associated with the user, or an avatar associated with the user.

10. The method of claim 8, wherein one or more of the first environmental data or the second environmental data comprises one or more of:
a location of the computing device;
an air quality associated with the location of the computing device;
a degree associated with the location of the computing device;
a humidity associated with the location of the computing device;
a pollution level associated with the location of the computing device;
a weather forecast associated with the location of the computing device;
a noise level associated with the location of the computing device;
an ambient light associated with the location of the computing device;
an atmospheric pressure associated with the location of the computing device; or
a time of day associated with the location of the computing device.

11. The method of claim 8, further comprising executing the one or more machine-learning models further trained to generate the MFA value by assigning one or more weights to each of the first biometric identity data and the first environmental data.

12. The method of claim 8, further comprising executing the one or more machine-learning models further trained to generate the dynamic threshold based at least in part on real-time or near real-time second environmental data associated with the computing device.

13. The method of claim 8, further comprising:
in response to determining that the MFA value fails to satisfy the dynamic threshold, forgoing initiating the execution of the sequence of user interactions with the at least one software application.

14. The method of claim 8, wherein the one or more machine-learning models comprises one or more of a neuromorphic image compression (NIC) model, a convolutional neural network (CNN), a spiking neural network (SNN), an autoencoder (AE), a variational autoencoder (VAE), a generative adversarial network (GAN), or a bidirectional generative adversarial network (BiGAN).

15. A non-transitory computer-readable medium storing instructions that, when executed by one or more processors, cause the one or more processors to:
receive a request to initiate an execution of a sequence of user interactions with at least one software application, and, in response:
receive, based on first sensor data obtained from one or more first sensors of a computing device, first biometric identity data associated with a user of the computing device;
receive, based on second sensor data obtained from one or more second sensors of the computing device, first environmental data associated with the computing device;
execute one or more machine-learning models trained to generate a multifactor authentication (MFA) value and a dynamic threshold based at least in part on whether the first biometric identity data and the first environmental data corresponds to second biometric identity data associated with the user and second environmental data associated with the computing device, respectively, wherein the dynamic threshold comprises an adaptable acceptable range for the MFA value so as to authenticate the user; and
in response to determining that the MFA value satisfies the dynamic threshold, initiate the execution of the sequence of user interactions with the at least one software application.

16. The non-transitory computer-readable medium of claim 15, wherein one or more of the first biometric identity data or the second biometric identity data comprises one or more of image data associated with the user, voice data associated with the user, fingerprint data associated with the user, handprint data associated with the user, eye tracking data associated with the user, face tracking data associated with the user, hand tracking data associated with the user, full-body tracking data associated with the user, tactile data associated with the user, or an avatar associated with the user.

17. The non-transitory computer-readable medium of claim 15, wherein one or more of the first environmental data or the second environmental data comprises one or more of:
a location of the computing device;
an air quality associated with the location of the computing device;
a degree associated with the location of the computing device;
a humidity associated with the location of the computing device;
a pollution level associated with the location of the computing device;
a weather forecast associated with the location of the computing device;
a noise level associated with the location of the computing device;
an ambient light associated with the location of the computing device;
an atmospheric pressure associated with the location of the computing device; or
a time of day associated with the location of the computing device.

18. The non-transitory computer-readable medium of claim 15, wherein the instructions further cause the one or more processors to execute the one or more machine-learning models further trained to generate the MFA value by assigning one or more weights to each of the first biometric identity data and the first environmental data.

19. The non-transitory computer-readable medium of claim 15, wherein the instructions further cause the one or more processors to execute the one or more machine-learning models further trained to generate the dynamic threshold based at least in part on real-time or near real-time second environmental data associated with the computing device.

20. The non-transitory computer-readable medium of claim 15, wherein the instructions further cause the one or more processors to:
in response to determining that the MFA value fails to satisfy the dynamic threshold, forgo initiating the execution of the sequence of user interactions with the at least one software application.
